(19) United States
(12) Patent Application Publication
(10) Pub. No.: US 2016/0099482 A1
(43) Pub. Date: Apr. 7, 2016

(54) Solid-State Batteries with Improved Electrode Conductivity and Methods for Forming the Same

(71) Applicant: Intermolecular, Inc., San Jose, CA (US)

(72) Inventors: Abraham Anapolsky, San Mateo, CA (US); Jeroen Van Duren, Palo Alto, CA (US)

(21) Appl. No.: 14/508,217

(22) Filed: Oct. 7, 2014

(51) Int. Cl. H01M 10/058; H01M 10/0562; H01M 10/04; H01M 10/052

(52) U.S. Cl. CPC H01M 10/058; H01M 10/052; H01M 10/0562; H01M 10/04

(57) ABSTRACT

Embodiments provided herein describe solid-state lithium batteries and methods for forming such batteries. A first current collector is provided. A first electrode is formed above the first current collector. The first electrode includes lithium and cobalt and is formed using PVD in a gaseous environment including at least 96% argon. An electrolyte is formed above the first electrode. A second electrode is formed above the electrolyte. A second current collector is formed above the second electrode.

### TECHNICAL FIELD

The present invention relates to solid-state batteries. More particularly, this invention relates to solid-state lithium batteries with improved electrode conductivity and methods for forming such batteries.

### BACKGROUND

As electronic devices continue to get smaller, while the performance thereof continues to improve, there is an ever growing need for smaller, lighter, and more powerful batteries that demonstrate suitable reliability and longevity.

One possible solution for these batteries is solid-state lithium batteries. Current goals with respect to solid-state lithium batteries include a volumetric energy density greater than 1000 Watt hours per liter (Whr/L). Ideally, the batteries would be able to cycle to 500 cycles with less than 20% volumetric energy density loss at temperatures between 30° C. and 40° C. It is also desirable to keep the batteries, and of the components therein, as thin as possible while maintaining such performance.

Using conventional materials, such as lithium-cobalt oxide, in the cathodes of the batteries typically requires the cathode to be at least 10 micrometers thick for the overall system to have an energy density that greater than 625 Whr/L, let alone higher.

However, current lithium-cobalt oxide electrodes grown on conductive films (e.g. gold) are limited to a thickness of about 4 micrometers. When the thickness is increased to greater than 5 micrometers, the electrodes have high Ohmic resistivity. At moderate discharge rates (e.g., greater than C/5), the Ohmic loss may severely reduce utilization of the full capacity of the electrode, which in turn results in an overall decrease of energy for the batteries.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIG. 1 illustrates a schematic diagram for implementing combinatorial processing and evaluation using primary, secondary, and tertiary screening.

FIG. 2 is a simplified schematic diagram illustrating a general methodology for combinatorial process sequence integration that includes site isolated processing and/or conventional processing in accordance with some embodiments.

FIG. 3 is a simplified schematic diagram illustrating an integrated high productivity combinatorial (HPC) system in accordance with some embodiments.

FIG. 4 is a simplified schematic diagram illustrating a sputter processing chamber configured to perform combinatorial processing and full substrate processing in accordance with some embodiments.

FIGS. 5, 6, 7, and 8 are cross-sectional views of a substrate, illustrating the formation of a current collector and electrode above.

FIG. 9 is a cross-sectional side view of a solid-state lithium battery according to some embodiments.

FIG. 10 is a flow chart illustrating a method for forming a solid-state battery according to some embodiments.

### DETAILED DESCRIPTION

A detailed description of one or more embodiments is provided below along with accompanying figures. The detailed description is provided in connection with such embodiments, but is not limited to any particular example. The scope is limited only by the claims, and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

The term “horizontal” as used herein will be understood to be defined as a plane parallel to the plane or surface of the substrate, regardless of the orientation of the substrate. The term “vertical” will refer to a direction perpendicular to the horizontal as previously defined. Terms such as “above”, “below”, “bottom”, “top”, “side” (e.g. sidewall), “higher”, “lower”, “upper”, “over”, and “under”, are defined with respect to the horizontal plane. The term “on” means there is direct contact between the elements. The term “above” will allow for intervening elements.

Currently, high utilization of thin solid film lithium-cobalt oxide electrodes grown on a conductive film (e.g. gold) is limited to a thickness of about 4 micrometers (μm) due to, for example, high Ohmic resistivity. Films thicker than 5 micrometers show decreased utilization of the full capacity of the electrode at charge rates above C/5. Thus, the batteries suffer from a loss of overall energy.

When sputtered lithium-cobalt oxide (LiCO₂) films are exposed to air, a small amount of lithium in the film is converted to lithium carbonate (LiCO₃), some of which may be formed in cracks which manifest in the films, especially relatively thick films (e.g., 5 μm or more). During the subsequent high temperature anneal (e.g., greater than 600° C.), the lithium carbonate is reduced to carbon, and the lithium is reincorporated into the lithium-cobalt oxide cathode. The additional carbon on the surface and in the cracks of the electrode (e.g., cathode) improves overall electrical conductivity.

In some embodiments, methods are provided for intentionally forming (more) lithium carbonate on the surface of the electrode. In some embodiments, the electrode includes lithium-cobalt oxide and is formed using physical vapor deposition (PVD) (e.g., sputtering) in a gaseous environment of mostly argon (e.g., 4% or less oxygen in argon). In some embodiments, after the electrode is formed, it is exposed to air before being annealed.

In some embodiments, combinatorial methods and systems for evaluating and developing electrodes, and solid-state lithium batteries in general, are also provided. In some embodiments, a plurality of regions (e.g., site-isolated regions) is designated on at least one substrate (e.g., a glass substrate). A first solid-state lithium battery material (e.g., lithium-cobalt oxide) is formed on a first of the plurality of regions on the at least one substrate with a first set of processing conditions. A second solid-state lithium battery material is formed on a second of the plurality of regions on the at least one substrate with a second set of processing conditions. The second set of processing conditions is different than the first set of processing conditions. However, it should be understood, that in some embodiments, the use of the same set of processing conditions may be repeated on several of the regions (or one or more substrate) to test for consistency and repeatability.

The first solid-state lithium battery material and the second solid-state lithium battery material may then be characterized. In some embodiments, the characterizing of the solid-state lithium battery material(s) includes testing or evaluating the solid-state lithium battery material(s) with respect to properties relevant to the use of the solid-state lithium battery material(s) in solid-state lithium batteries (e.g., volumetric energy density). One of the first set of processing conditions and the second set of processing conditions may be selected based on the characterizing of the first solid-state lithium battery material and the second solid-state lithium battery material.

As such, in accordance with some embodiments, combinatorial processing may be used to produce and evaluate different materials, substrates, chemicals, consumables, processes, coating stacks, and techniques related to solid-state lithium battery materials, as well as build structures or determine how solid-state lithium battery materials coat, fill or interact with existing structures in order to vary materials, unit processes and/or process sequences across multiple site-isolated regions on the substrate(s). These variations may relate to specifications such as temperatures, exposure times, layer thicknesses, chemical compositions of majority and minority elements of layers, gas compositions, chemical compositions of wet and dry surface chemistries, power and pressure of sputter deposition conditions, humidity, etc. of the formulations and/or the substrates at various stages of the screening processes described herein. However, it should be noted that in some embodiments, the chemical composition (e.g., of the solid-state lithium battery material and/or of the other components) remains the same, while other parameters are varied, and in other embodiments, the chemical composition is varied.

As part of the discovery, optimization and qualification of each unit process, it is desirable to be able to i) test different materials, ii) test different processing conditions within each unit process module, iii) test different sequencing and integration of processing modules within an integrated processing tool, iv) test different sequencing of processing tools in executing different process sequence integration flows, and combinations thereof in the manufacture of devices such as solid-state batteries. In particular, there is a need to be able to test i) more than one material, ii) more than one processing condition, iii) more than one sequence of processing conditions, iv) more than one process sequence integration flow, and combinations thereof, collectively known as “combinatorial process sequence integration,” on a single monolithic substrate without the need of consuming the equivalent number of monolithic substrates per material(s), processing condition(s), sequence(s) of processing conditions, sequence(s) of processes, and combinations thereof. This can greatly improve both the speed and reduce the costs associated with the discovery, implementation, optimization, and qualification of material(s), process(es), and process integration sequence(s) required for manufacturing.

Systems and methods for High Productivity Combinatorial (HPC) processing are described in U.S. Pat. No. 7,544,574, filed on Feb. 10, 2006, U.S. Pat. No. 7,824,935, filed on Jul. 2, 2008, U.S. Pat. No. 7,871,928, filed on May 4, 2009, U.S. Pat. No. 7,902,063, filed on Feb. 10, 2006, and U.S. Pat. No. 7,947,531, filed on Aug. 28, 2009, which are all herein incorporated by reference. Systems and methods for HPC processing are further described in U.S. patent application Ser. No. 11/352,077, filed on Feb. 10, 2006, claiming priority from Oct. 15, 2005, U.S. patent application Ser. No. 11/419,174, filed on May 18, 2006, claiming priority from Oct. 15, 2005, U.S. patent application Ser. No. 11/674,132, filed on Feb. 12, 2007, claiming priority from Oct. 15, 2005, and U.S. patent application Ser. No. 11/674,137, filed on Feb. 12, 2007, claiming priority from Oct. 15, 2005 which are all herein incorporated by reference.

HPC processing techniques have been successfully adapted to wet chemical processing such as etching and cleaning. HPC processing techniques have also been successfully adapted to deposition processes such as physical vapor deposition (PVD), atomic layer deposition (ALD), and chemical vapor deposition (CVD).

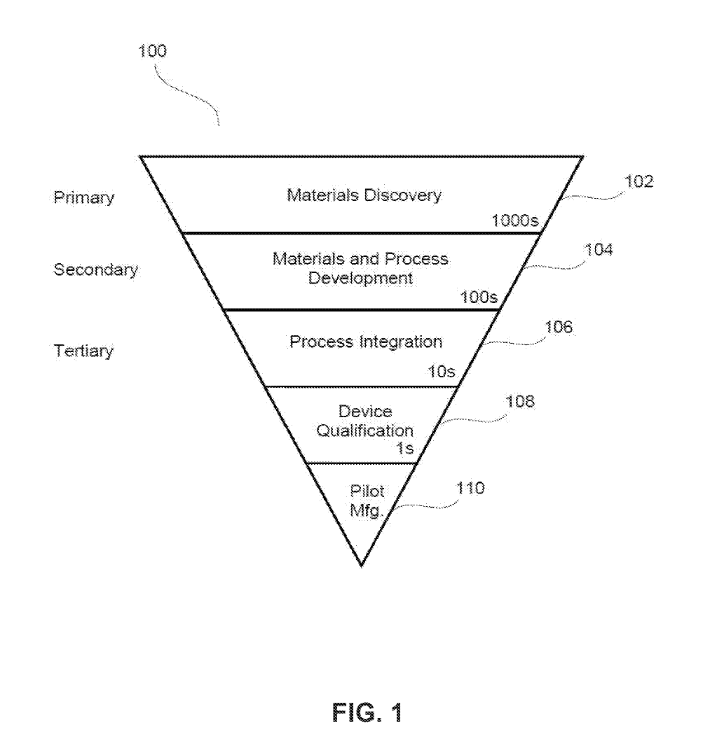

FIG. 1 illustrates a schematic diagram 100 for implementing combinatorial processing and evaluation using primary, secondary, and tertiary screening. The schematic diagram 100 illustrates that the relative number of combinatorial processes run with a group of substrates decreases as certain materials and/or processes are selected. Generally, combinatorial processing includes performing a large number of processes during a primary screen, selecting promising candidates from those processes, performing the selected processing during a secondary screen, selecting promising candidates from the secondary screen for a tertiary screen, and so on. In addition, feedback from later stages to earlier stages can be used to refine the success criteria and provide better screening results.

For example, thousands of materials are evaluated during a materials discovery stage 102. Materials discovery stage 102 is also known as a primary screening stage performed using primary screening techniques. Primary screening techniques may include dividing substrates into coupons and depositing materials using varied processes. The materials are then evaluated (e.g., with respect to properties relevant to use of the material(s) in solid-state lithium batteries), and promising candidates are advanced to the secondary screen, or materials and process development stage 104.

Evaluation, or testing, performed on the materials and/or devices related to solid-state batteries may include testing related to the volumetric energy density (i.e., Coulombs per unit volume), average voltage during discharge, utilization at various discharge rates, and/or cycle life, or number of charge and discharge cycles until the battery retains a particular amount (e.g. 80%) of its initial capacity. Evaluation may also be performed using various methods, such as atomic force microscopy (AFM), scanning electron microscopy (SEM), optical transmission and reflectance testing, X-Ray Diffraction (XRD), X-Ray Fluorescence (XRF), or any combination thereof.

The materials and process development stage 104 may evaluate hundreds of materials (i.e., a magnitude smaller than the primary stage) and may focus on the processes used to deposit or develop those materials. Promising materials and processes are again selected, and advanced to the tertiary screen or process integration stage 106, where tens of materials and/or processes and combinations are evaluated. The tertiary screen or process integration stage 106 may focus on integrating the selected processes and materials with other processes and materials.

The most promising materials and processes from the tertiary screen are advanced to device qualification 108. In device qualification, the materials and processes selected are evaluated for high volume manufacturing, which normally is conducted on full substrates within production tools, but need not be conducted in such a manner. The results are evaluated to determine the efficacy of the selected materials and processes. If successful, the use of the screened materials and processes can proceed to pilot manufacturing 110.

The schematic diagram 100 is an example of various techniques that may be used to evaluate and select materials and processes for the development of new materials and processes. The descriptions of primary, secondary, etc. screening and the various stages 102-110 are arbitrary and the stages may overlap, occur out of sequence, be described and be performed in many other ways.

This application benefits from High Productivity Combinatorial (HPC) techniques described in U.S. patent application Ser. No. 11/674,137 filed on Feb. 12, 2007, which is hereby incorporated for reference in its entirety. Portions of the '137 application have been reproduced below to enhance the understanding of the present invention. The embodiments described herein enable the application of combinatorial techniques to process sequence integration in order to arrive at a globally optimal sequence of, for example, device manufacturing operations by considering interaction effects between the unit manufacturing operations, the process conditions used to effect such unit manufacturing operations, hardware details used during the processing, as well as materials characteristics of components utilized within the unit manufacturing operations. Rather than only considering a series of local optimums (i.e., where the best conditions and materials for each manufacturing unit operation is considered in isolation), the embodiments described below consider interactions effects introduced due to the multitude of processing operations that are performed and the order in which such multitude of processing operations are performed when fabricating a device. A global optimum sequence order is therefore derived and as part of this derivation, the unit processes, unit process parameters and materials used in the unit process operations of the optimum sequence order are also considered.

The embodiments described further analyze a portion or sub-set of the overall process sequence used to manufacture a device. Once the subset of the process sequence is identified for analysis, combinatorial process sequence integration testing is performed to optimize the materials, unit processes, hardware details, and process sequence used to build that portion of the device or structure. During the processing of some embodiments described herein, structures are formed on the processed substrate that are equivalent to the structures formed during actual production of the device. For example, such structures may include, but would not be limited to, barrier layers, reflective layers, dielectric layers, or any other series of layers or unit processes that create an intermediate structure found on devices such as low-e panels. While the combinatorial processing varies certain materials, unit processes, hardware details, or process sequences, the composition or thickness of the layers or structures or the action of the unit process, such as cleaning, surface preparation, deposition, surface treatment, etc. is substantially uniform through each discrete region. Furthermore, while different materials or unit processes may be used for corresponding layers or steps in the formation of a structure in different regions of the substrate during the combinatorial processing, the application of each layer or use of a given unit process is substantially consistent or uniform throughout the different regions in which it is intentionally applied. Thus, the processing is uniform within a region (inter-region uniformity) and between regions (intra-region uniformity), as desired. It should be noted that the process can be varied between regions, for example, where a chemical composition or thickness of a layer is between the regions, etc., as desired by the design of the experiment.

The result is a series of regions on the substrate that contain structures or unit process sequences that have been uniformly applied within that region and, as applicable, across different regions. This process uniformity allows comparison of the properties within and across the different regions such that the variations in test results are due to the varied parameter (e.g., materials, unit processes, unit process parameters, hardware details, or process sequences) and not the lack of process uniformity. In the embodiments described herein, the positions of the discrete regions on the substrate can be defined as needed, but are preferably systematized for ease of tooling and design of experimentation. In addition, the number, variants and location of structures within each region are designed to enable valid statistical analysis of the test results within each region and across regions to be performed.

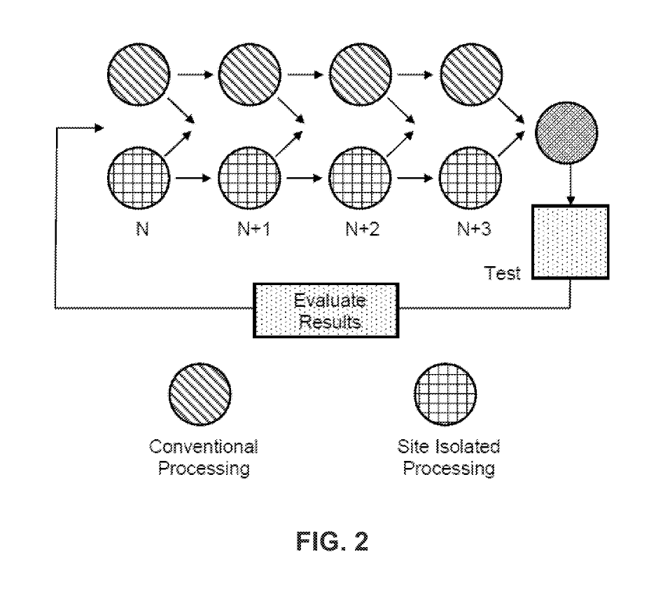

FIG. 2 is a simplified schematic diagram illustrating a general methodology for combinatorial process sequence integration that includes site isolated processing and/or conventional processing in accordance with some embodiments. In some embodiments, the substrate is initially processed using conventional process N. In some embodiments, the substrate is then processed using site isolated process N+1. During site isolated processing, an HPC module may be used, such as the HPC module described in U.S. patent application Ser. No. 11/352,077, filed on Feb. 10, 2006. The substrate can then be processed using site isolated process N+2, and thereafter processed using conventional process N+3. Testing is performed and the results are evaluated. The testing can include physical, chemical, acoustic, magnetic, electrical, optical, etc. tests. From this evaluation, a particular process from the various site isolated processes (e.g. from steps N+1 and N+2) may be selected and fixed so that additional combinatorial process sequence integration may be performed using site isolated processing for either process N or N+3. For example, a next process sequence can include processing the substrate using site isolated process N, conventional processing for processes N+1, N+2, and N+3, with testing performed thereafter.

It should be appreciated that various other combinations of conventional and combinatorial processes can be included in the processing sequence with regard to FIG. 2. That is, the combinatorial process sequence integration can be applied to any desired segments and/or portions of an overall process flow. Characterization, including physical, chemical, acoustic, magnetic, electrical, optical, etc. testing, can be performed after each process operation, and/or series of process operations within the process flow as desired. The characterization (or testing) may be performed using various methods, such as atomic force microscopy (AFM), scanning electron microscopy (SEM), optical transmission and reflectance testing, X-Ray Diffraction (XRD), X-Ray Fluorescence (XRF), or any combination thereof.

The feedback provided by the testing is used to select certain materials, processes, process conditions, and process sequences and eliminate others. Furthermore, the above flows can be applied to entire monolithic substrates, or portions of monolithic substrates such as coupons.

Under combinatorial processing operations the processing conditions at different regions can be controlled independently. Consequently, process material amounts, reactant species, processing temperatures, processing times, processing pressures, processing flow rates, processing powers, processing reagent compositions, the rates at which the reactions are quenched, deposition order of process materials, process sequence steps, hardware details, etc., can be varied from region to region on the substrate. Thus, for example, when exploring materials, a processing material delivered to a first and second region can be the same or different. If the processing material delivered to the first region is the same as the processing material delivered to the second region, this processing material can be offered to the first and second regions on the substrate at different concentrations. In addition, the material can be deposited under different processing parameters. Parameters which can be varied include, but are not limited to, process material amounts, reactant species, processing temperatures, processing times, processing pressures, processing flow rates, processing powers, processing reagent compositions, the rates at which the reactions are quenched, atmospheres in which the processes are conducted, an order in which materials are deposited, hardware details of the gas distribution assembly, etc. It should be appreciated that these process parameters are exemplary and not meant to be an exhaustive list as other process parameters commonly used in device manufacturing may be varied.

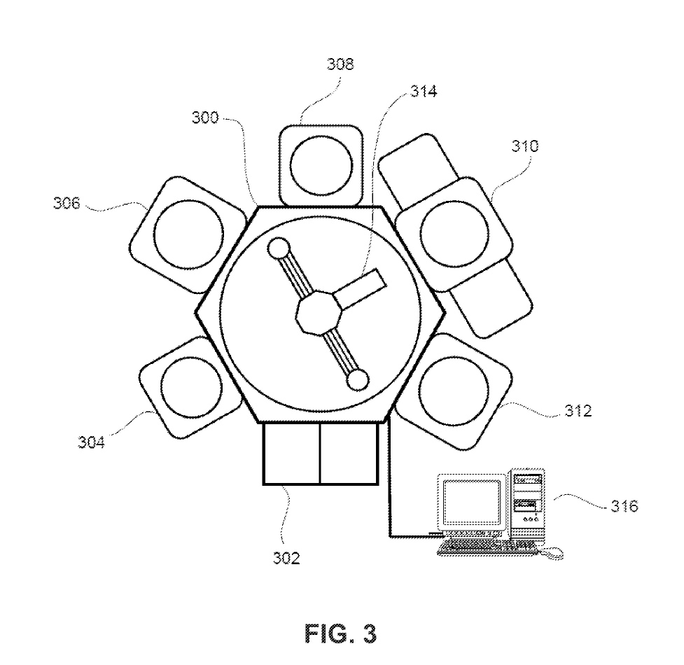

FIG. 3 is a simplified schematic diagram illustrating an integrated high productivity combinatorial (HPC) system in accordance with some embodiments. HPC system includes a frame 300 supporting a plurality of processing modules. It should be appreciated that frame 300 may be a unitary frame in accordance with some embodiments. In some embodiments, the environment within frame 300 is controlled. Load lock/factory interface 302 provides access into the plurality of modules of the HPC system. Robot 314 provides for the movement of substrates (and masks) between the modules and for the movement into and out of the load lock 302. Modules (or processing tools) 304-312 may be any set of modules and preferably include one or more combinatorial modules. For example, module 304 may be an orientation/degassing module, module 306 may be a clean module, either plasma or non-plasma based, modules 308 and/or 310 may be combinatorial/conventional dual purpose modules. Module 312 may provide conventional clean or degas as necessary for the experiment design.

Any type of chamber or combination of chambers may be implemented and the description herein is merely illustrative of one possible combination and not meant to limit the potential chamber or processes that can be supported to combine combinatorial processing or combinatorial plus conventional processing of a substrate or wafer. In some embodiments, a centralized controller, i.e., computing device 316, may control the processes of the HPC system, including the power supplies and synchronization of the duty cycles described in more detail below. Further details of one possible HPC system are described in U.S. application Ser. No. 11/672,478 filed Feb. 7, 2007, now U.S. Pat. No. 7,867,904 and claiming priority to U.S. Provisional Application No. 60/832,248 filed on Jul. 19, 2006, and U.S. application Ser. No. 11/672,473, filed Feb. 7, 2007, and claiming priority to U.S. Provisional Application No. 60/832,248 filed on Jul. 19, 2006, which are all herein incorporated by reference. With HPC system, a plurality of methods may be employed to deposit material upon a substrate employing combinatorial processes.

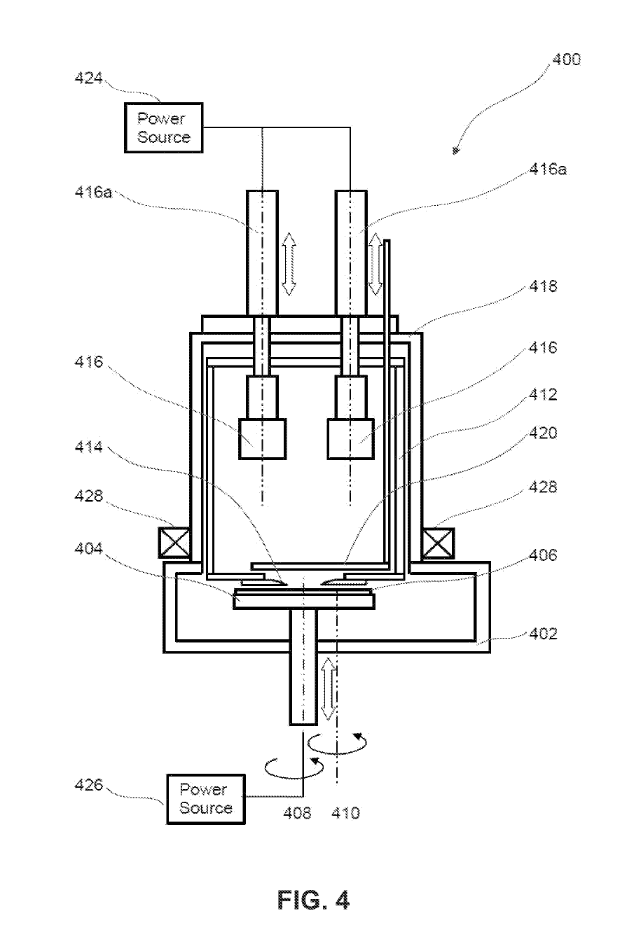

FIG. 4 is a simplified schematic diagram illustrating a PVD chamber (or processing tool), more particularly, a sputter chamber, configured to perform combinatorial processing and full substrate processing in accordance with some embodiments. Processing chamber 400 includes a bottom chamber portion 402 disposed under top chamber portion 418. Within bottom portion 402, substrate support 404 is configured to hold a substrate 406 disposed thereon and can be any known substrate support, including but not limited to a vacuum chuck, electrostatic chuck or other known mechanisms. Substrate support 404 is capable of both rotating around its own central axis 408 (referred to as “rotation” axis), and rotating around an exterior axis 410 (referred to as “revolution” axis). Such dual rotary substrate support is central to combinatorial processing using site-isolated mechanisms. Other substrate supports, such as an XY table, can also be used for site-isolated deposition. In addition, substrate support 404 may move in a vertical direction. It should be appreciated that the rotation and movement in the vertical direction may be achieved through known drive mechanisms which include magnetic drives, linear drives, worm screws, lead screws, a differentially pumped rotary feed through drive, etc. Power source 426 provides a bias power to substrate support 404 and substrate 406 and produces a negative bias voltage on substrate 406. In some embodiments, power source 426 provides a radio frequency (RF) power sufficient to take advantage of the high metal ionization to improve step coverage of vias and trenches of patterned wafers. In some embodiments, the RF power supplied by power source 426 is pulsed and synchronized with the pulsed power from power source 424.

Substrate 406 may be a conventional round 200 mm, 300 mm, or any other larger or smaller substrate/wafer size. In some embodiments, substrate 406 may be a square, rectangular, or other shaped substrate. In some embodiments, substrate 406 is made of glass. However, in other embodiments, the substrate 406 is made of a semiconductor material, such as silicon. One skilled in the art will appreciate that substrate 406 may be a blanket substrate, a coupon (e.g., partial wafer), or even a patterned substrate having predefined regions. In some embodiments, substrate 406 may have regions defined through the processing described herein. The term region is used herein to refer to a localized (or site-isolated) area on a substrate which is, was, or is intended to be used for processing or formation of a selected material. The region can include one region and/or a series of regular or periodic regions predefined on the substrate. The region may have any convenient shape, e.g., circular, rectangular, elliptical, wedge-shaped, etc. In the semiconductor field, a region may be, for example, a test structure, single die, multiple dies, portion of a die, other defined portion of substrate, or an undefined area of a substrate, e.g., blanket substrate which is defined through the processing.

Top chamber portion 418 of chamber 400 in FIG. 4 includes process kit shield 412, which defines a confinement region over a radial portion of substrate 406. Process kit shield 412 is a sleeve having a base (optionally integrated with the shield) and an optional top within chamber 400 that may be used to confine a plasma generated therein. The generated plasma will dislodge atoms from a target and the sputtered atoms will deposit on an exposed surface of substrate 406 to combinatorial process regions of the substrate in a site-isolated manner (e.g., such that only the particular region on the substrate is processed) in some embodiments. In other embodiments, full wafer processing can be achieved by optimizing gun tilt angle and target-to-substrate spacing, and by using multiple process guns 416. Process kit shield 412 is capable of being moved in and out of chamber 400 (i.e., the process kit shield is a replaceable insert). In other embodiments, process kit shield 412 remains in the chamber for both the full substrate and combinatorial processing. Process kit shield 412 includes an optional top portion, sidewalls and a base. In some embodiments, process kit shield 412 is configured in a cylindrical shape, however, the process kit shield may be any suitable shape and is not limited to a cylindrical shape.

The base of process kit shield 412 includes an aperture 414 through which a surface of substrate 406 is exposed for deposition or some other suitable semiconductor processing operations. Aperture shutter 420 which is moveably disposed over the base of process kit shield 412. Aperture shutter 420 may slide across a bottom surface of the base of process kit shield 412 in order to cover or expose aperture, 414, in some embodiments. In other embodiments, aperture shutter 420 is controlled through an arm extension which moves the aperture shutter to expose or cover aperture 414. It should be noted that although a single aperture is illustrated, multiple apertures may be included. Each aperture may be associated with a dedicated aperture shutter or an aperture shutter can be configured to cover more than one aperture simultaneously or separately. Alternatively, aperture 414 may be a larger opening and aperture shutter 420 may extend with that opening to either completely cover the aperture or place one or more fixed apertures within that opening for processing the defined regions. The dual rotary substrate support 404 is central to the site-isolated mechanism, and allows any location of the substrate or wafer to be placed under the aperture 414. Hence, the site-isolated deposition is possible at any location on the wafer/substrate.

Although only two process guns 416 are visible in FIG. 4, any number of process guns may be included (e.g., one, three, four or more process guns). Process guns 416 are moveable in a vertical direction so that one or both of the guns may be lifted from the slots of the shield. Where more than one process gun is included, the plurality of process guns may be referred to as a cluster of process guns. In some embodiments, process guns 416 are oriented or angled so that a normal reference line extending from a planar surface of the target of the process gun is directed toward an outer periphery of the substrate in order to achieve good uniformity for full substrate deposition. The target/gun tilt angle depends on the target size, target-to-substrate spacing, target material, process power/pressure, etc.

Top chamber portion 418 of chamber 400 of FIG. 4 includes sidewalls and a top plate which house process kit shield 412. Arm extensions 416a which are fixed to process guns 416 may be attached to a suitable drive, (i.e., lead screw, worm gear, etc.), configured to vertically move process guns 416 toward or away from a top plate of top chamber portion 418. Arm extensions 416a may be pivotally affixed to process guns 416 to enable the process guns to tilt relative to a vertical axis. In some embodiments, process guns 416 tilt toward aperture 414 when performing combinatorial processing and tilt toward a periphery of the substrate being processed when performing full substrate processing. It should be appreciated that process guns 416 may tilt away from aperture 414 when performing combinatorial processing in other embodiments. In yet other embodiments, arm extensions 416a are attached to a bellows that allows for the vertical movement and tilting of process guns 416. Arm extensions 416a enable movement with four degrees of freedom in some embodiments. Where process kit shield 412 is utilized, the aperture openings are configured to accommodate the tilting of the process guns. The amount of tilting of the process guns may be dependent on the process being performed in some embodiments.

Power source 424 provides power for sputter guns 416 whereas power source 426 provides RF bias power to an electrostatic chuck. As mentioned above, the output of power source 426 is synchronized with the output of power source 424. It should be appreciated that power source 424 may output a direct current (DC) power supply or a radio frequency (RF) power supply. In other embodiments, the DC power is pulsed and the duty cycle is less than 30% on-time at maximum power in order to achieve a peak power of 10-15 kilowatts. Thus, the peak power for high metal ionization and high density plasma is achieved at a relatively low average power which will not cause any target overheating/cracking issues. It should be appreciated that the duty cycle and peak power levels are exemplary and not meant to be limiting as other ranges are possible and may be dependent on the material and/or process being performed.

Although not shown in detail, each of the sputter guns 416 may include a target that includes one or more materials to be deposited onto the substrate 406. In some embodiments, the various materials included in the target(s) are suitable for forming solid-state lithium batteries, such as gold, platinum, lithium, phosphorous, manganese, chromium, titanium, nickel, tungsten, scandium, vanadium, iron, cobalt, copper, yttrium, zirconium, lanthanum, hafnium, molybdenum, tantalum, and/or combinations thereof.

Using processing chamber 400, perhaps in combination with other processing tools, solid-state lithium battery materials may be developed and evaluated in the manner described above. In particular, in some embodiments, solid-state battery materials may be formed (or deposited) on different (i.e., two or more) site-isolated regions of substrate 406 (or on multiple substrates) under varying processing conditions (including, for example, the formation/deposition of different solid-state lithium battery materials). For example, (a first) solid-state battery material may be ejected from one of more of targets and deposited onto a first of the regions on substrate 406 under a first set of processing conditions, and either sequentially or simultaneously, (a second) solid-state battery material may be ejected from one of more of targets and deposited onto a second of the regions on substrate 406 under a different, second set of processing conditions.

The solid-state battery material(s) (and/or processing conditions) may then be characterized. In some embodiments, the characterizing of the solid-state battery material(s) includes testing or evaluating the solid-state battery material(s) with respect to properties relevant to the use of the materials in solid-state batteries. Particular materials and/or processing conditions may then be selected (e.g., for further testing or use in devices) based on the desired parameters or properties.

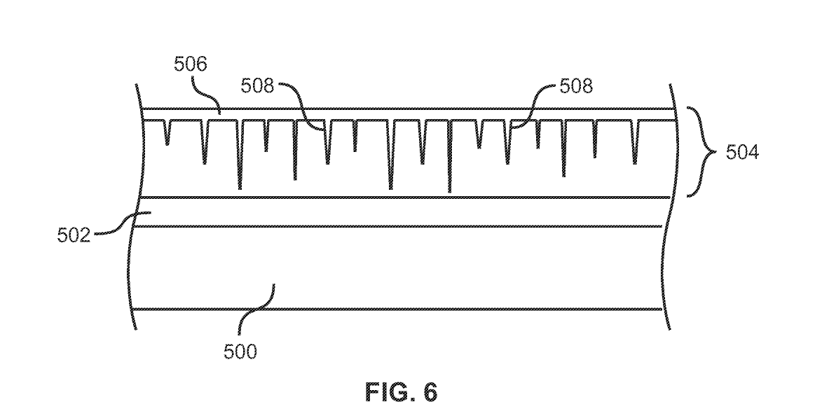

It should be understood that the development of the solid-state battery materials may involve the use of multiple processing tools, such as modules 304-312 in FIG. 3. For example, various other materials/layers (e.g., as shown in FIG. 6), in addition to the first electrode (or cathode), may be formed on each site-isolated region on the substrate, and additional processing steps, such as cleanings, may be performed at various stages of the processing, in processing tools/chambers different from the one in which the solid-state battery material(s) is formed. This processing may utilize several of the modules 304-312 and involve transporting the substrate between the modules in a controlled environment (e.g., without breaking vacuum).

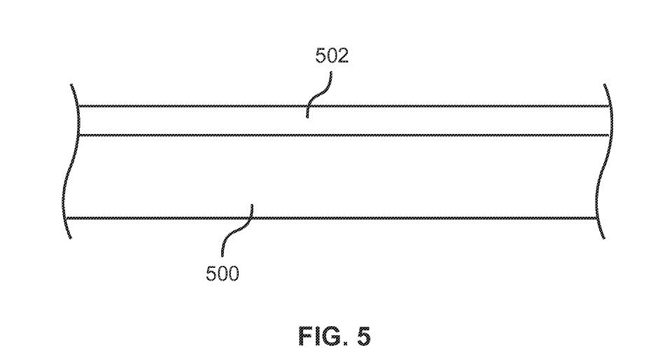

FIGS. 5-8 are cross-sectional views of a substrate, illustrating a method for forming an electrode for a solid-state battery, according to some embodiments. Referring to FIG. 5, a substrate 500 is provided. In some embodiments, the substrate 500 includes (or is made of) aluminum oxide (e.g., alumina), silicon oxide (e.g., silica), zirconium oxide (e.g., zirconia), aluminum nitride, a semiconductor material, such as silicon and/or germanium, a metal foil (e.g., aluminum, titanium, stainless steel, etc.), and/or a polymer or plastic. The substrate 500 may have a thickness of, for example, between about 50 μm and about 500 μm.

Still referring to FIG. 5, a current collector 502 is formed above the substrate 500. In some embodiments, the current collector 502 includes (or is made of) a noble metal, such as gold, platinum, cobalt, palladium, or a combination thereof. The current collector 502 may have a thickness of, for example, between about 0.1 μm and about 3.0 μm. The current collector may be formed using any suitable process, such as physical vapor deposition (PVD) (e.g., sputtering) or plating. In some embodiments, the cathode current collector 512 includes a layer of cobalt (e.g., 0.1 μm thick) and a thinner layer of gold formed over the cobalt.

As shown in FIG. 6, an electrode (e.g., a cathode) 504 is formed above the current collector 502. In some embodiments, the electrode 504 is made of a layer that includes lithium and cobalt (e.g., lithium-cobalt oxide) and has a thickness of, for example, between about 5 μm and about 15 μm, such as about 10 μm. The electrode 504 may be formed using PVD (e.g., sputtering). In particular, in some embodiments, the electrode is formed using sputtering in a gaseous environment of mostly argon, such as a gaseous environment consisting of at least 96% argon. For example, the gaseous environment may consist of 4% or less oxygen in argon (i.e., about 1-4% oxygen and 96-99% argon gas). After the electrode 504 is formed, in some embodiments the electrode 504 is exposed to air (i.e., the atmosphere).

As a result of the specific gaseous environment used for the deposition process and/or the exposure of the electrode 504 to air, the electrode 504 includes a lithium carbonate layer 506 at an upper portion (or surface) thereof. The electrode 504 may also include a series of cracks 508 which manifest during the deposition process. The cracks 508 may vary in width and depth. For example, in some embodiments, the width of the cracks 508 varies between about 1 nanometer (nm) to about 5 nm. The lithium carbonate layer 506 may have a thickness of, for example, between about 1 nanometer (nm) and about 10 nm.

Thus, in some embodiments, the lithium carbonate layer 506 completely fills at least some of the cracks 508 and completely covers the upper surface of the electrode 504. However, it should be understood that in embodiments in which the lithium carbonate layer 506 is relatively thin, the lithium carbonate layer 506 may not completely fill at least some of the cracks 506 (i.e., the lithium carbonate is only formed on the side walls of the cracks 506) and may not cover all of the upper surface of the electrode 504.

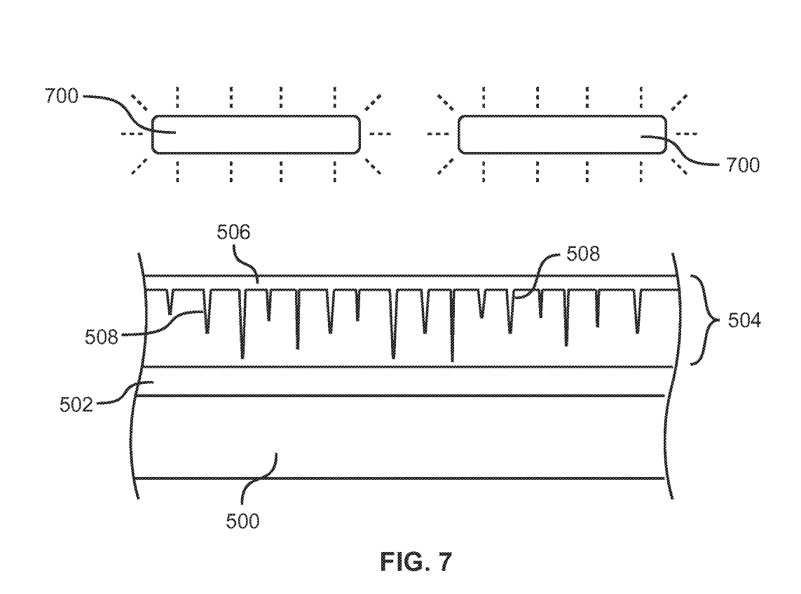

Referring now to FIG. 7, the substrate 500, as well as the current collector 502 and the electrode 504, are subjected to a heating process to, for example, to anneal the electrode 504 and adjust the crystallographic orientation of the material of the electrode 504. In some embodiments, the heating process is performed using heating elements 700. The heating process may be performed in the same processing chamber in which the electrode 504 (and perhaps the current collector 502) is formed (i.e., “in situ”). Alternatively, the heating process may be performed in a different processing chamber than that used to form the electrode 504 (i.e., “ex situ”). In some embodiments, the electrode 504 is heated to a temperature of, for example, greater than about 600° C. (e.g., between about 600° C. and about 800° C.) during the heating process. The heating process may be performed in a gaseous environment including oxygen, nitrogen, argon, and/or hydrogen (e.g., 80% nitrogen, 20% oxygen, air/atmosphere, etc.) with either ambient humidity, or no humidity. In some embodiments, the heating process is performed for a duration of, for example, greater than 30 minutes (e.g., 30-60 minutes). The heating process may utilize a temperature ramp rate of, for example, between about 5° C. and about 10° C. per minute (e.g., starting from room temperature).

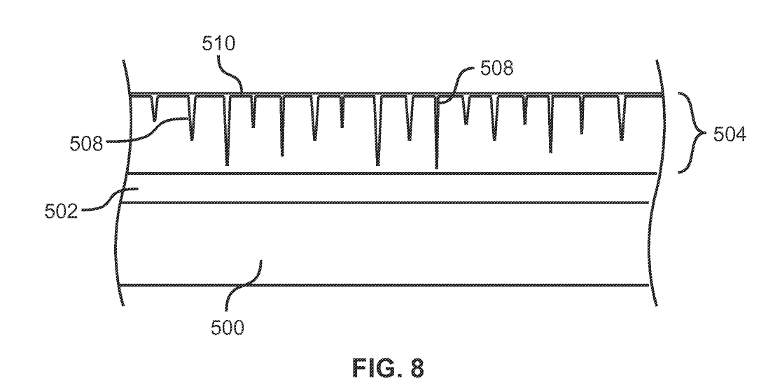

FIG. 8 illustrates the electrode 504 after the heating process. In some embodiments, the heating processes causes the lithium carbonate layer 506 to be reduced to carbon, while at least some of the lithium therein is reincorporated into the primary material of the electrode 504 (e.g., lithium-cobalt oxide). As a result, a carbon layer 510 remains (or is left) at the upper surface of the electrode 504. In some embodiments, the carbon layer 510 has a thickness of, for example, between about 1 nm and about 5 nm. As such, in some embodiments, the carbon layer 510 completely fills the cracks 508 in the electrode 508 and covers the entire surface of the electrode 504. However, in some embodiments, the carbon layer 510 may not completely fill the cracks (i.e., only be formed on the side walls of the cracks 508) and not cover the entire surface of the electrode 504.

Although not specifically shown, in some embodiments in which the carbon layer 510 complete covers the electrode 504, at least some of the material of the carbon layer 510 is removed from the electrode 504. This process may be performed using, for example, a light ion etch and/or a solvent treatment. In embodiments in which “excess” carbon is removed, after the removal process, the material of the carbon layer 510 may only reside in the cracks 508 (i.e., the carbon layer 510 is completely removed from the top-most surface of the electrode 504). However, in other embodiments, a thin layer (e.g., 1-5 nm) of carbon may be left on the top-most surface of the electrode.

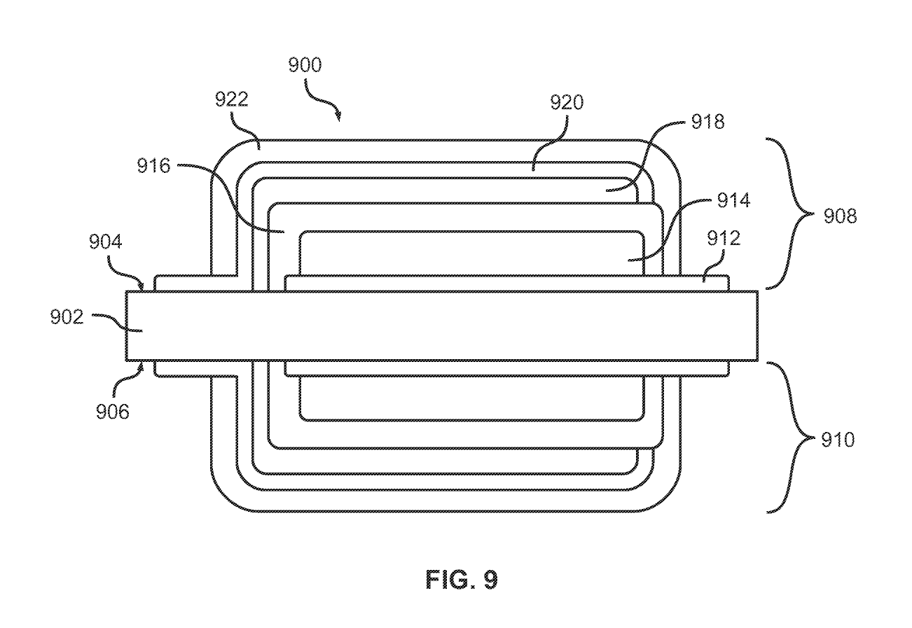

FIG. 9 illustrates a solid-state lithium battery (or battery cell) 900, according to some embodiments of the present invention. The battery 900 includes a substrate 902 having a first side 904 and a second side 906. In some embodiments, the substrate 902 is similar to the substrate 500 described above. Thus, the substrate 902 may include (or be made of) aluminum oxide (e.g., alumina), silicon oxide (e.g., silica), zirconium oxide (e.g., zirconia), aluminum nitride, a semiconductor material, such as silicon and/or germanium, a metal foil (e.g., aluminum, titanium, stainless steel, etc.), and/or a polymer or plastic. The substrate may have a thickness of, for example, between about 50 μm and about 500 μm.

The embodiment shown in FIG. 9 is a “double-sided” configuration. Thus, the battery 900 includes a first battery stack 908 formed on the first side 904 of the substrate 902 and a second battery stack 910 formed on the second side 906 of the substrate 902. In some double-sided embodiments, the first and second battery stacks 908 and 910 are identical, or substantially identical. Thus, for the purposes of this description, although only the first battery stack 908 is described in detail, it should be understood that the second battery stack 910 may be identical. In other embodiments, a “single-sided” configuration is used in which a battery stack is only formed on one side of the substrate 902.

Still referring to FIG. 9, the first battery stack 908 includes an cathode (or first) current collector 912, a cathode (or first electrode) 914, an electrolyte 916, an anode (or second electrode) 918, an anode (or second) current collector 920, and a protective layer 922.

The various layers (or components) in the battery stack 908 may be formed sequentially (i.e., from bottom to top) above the substrate 902 using, for example, physical vapor deposition (PVD) and/or reactive sputtering processing, or any other processes (e.g., plating) that are suitable depending on the material(s), thicknesses, etc. Although the components may be described as being formed “above” the previous component (or the substrate), it should be understood that in some embodiments, each layer is formed directly on (and adjacent to) the previously provided/formed component. In some embodiments, additional components (or layers) may be included between the components shown in FIG. 9 (as well as those shown in FIGS. 5-8), and other processing steps may also be performed between the formation of various components.

Still referring to FIG. 9, the cathode current collector 912 is formed above the substrate 902 (e.g., above the first side 904 of the substrate 902), and may be similar to the current collector 502 described above. Thus, in some embodiments, the cathode current collector 912 includes (or is made of) a noble metal, such as gold, platinum, or a combination thereof, and is formed using, for example, PVD or plating. The cathode current collector 912 may have a thickness of, for example, between about 0.1 μm and about 3.0 μm. As shown in FIG. 9, the cathode current collector 912 may be selectively formed on the substrate 902 such that it does not cover some portions of the substrate 902.

The cathode (or first electrode) 914 is formed above the cathode current collector 512. Although not shown in detail in FIG. 9, the cathode 914 may be similar to the electrode 504 and may be formed in a manner similar to that described above and shown in FIGS. 5-8. In the embodiment shown in FIG. 9, the cathode 914 is selectively formed above the cathode current collector 912 such that no portion of it is in direct contact with the substrate 902.

As shown in FIG. 9, the electrolyte 916 is formed above the cathode 914. In some embodiments, the electrolyte 916 includes, or is made of, lithium-phosphorous oxynitride (i.e., LiPON). The LiPON may be a “solid” electrolyte (i.e., an electrolyte that does not have a liquid component) formed using PVD, such as a sputtering process, such that the battery 900 is an “all solid-state” lithium battery. In some embodiments, the electrolyte 916 has a thickness of, for example, between about 1.0 μm and about 2.0 μm. As shown, in the depicted embodiment, the electrolyte 916 is formed such that cover the “ends” of the cathode 914.

The anode (or second electrode) 918 is formed above the electrolyte 916. In some embodiments, the anode 918 includes (or is made of) lithium metal. The anode 918 may have a thickness of, for example, between 1.0 μm and 5.0 μm. In the depicted embodiment, the anode 918 is formed such that it covers an end of the electrolyte 916 opposite an exposed end of the cathode current collector 912.

The anode (or second) current collector 920 is formed above the anode 918. In some embodiments, the anode current collector 920 includes (or is made of) a conductive material that is thermodynamically and chemically stable with the material (e.g., lithium metal) of the anode 918. Suitable materials include scandium, titanium, vanadium, chromium, manganese, iron, cobalt, nickel, copper, yttrium, zirconium, lanthanum, hafnium, molybdenum, tantalum, tungsten, titanium nitride, or a combination thereof.

The anode current collector 920 may have a thickness of, for example, between about 0.1 μm and about 3.0 μm. In the depicted embodiment, the anode current collector 920 is formed such that it covers both ends of the anode 918 and a portion thereof is formed directly on an exposed portion of the substrate 902.

The protective layer 922 is formed over the anode current collector 920. In some embodiments, the protective layer 922 includes (or is made of) a nitride, such as aluminum nitride or silicon nitride. The protective layer 922 may have a thickness of, for example, between about 1.0 μm and about 30 μm. As is shown in FIG. 9, the protective layer 922 may be formed to leave portions of the cathode current collector 912 and the anode current collector 920 exposed to form electrical connections to the battery 900.

During operation of the battery 900, when the battery 900 is allowed to discharge, lithium ions (i.e., Li⁺) migrate from the anode 918 to the cathode 914 by diffusing through the electrolyte 916. When the anode and cathode reactions are reversible, as for an intercalation compound or alloy such as LiPON, the battery 900 may be recharged by reversing the current. The difference in the electrochemical potential of the lithium determines the cell voltage. Electrical connections are made to the battery 900, for both discharging and charging, through the current collectors 912 and 920.

The performance of the battery 900 may be improved due to the method described above for forming the electrode (e.g., electrode 504 and/or cathode 914). In particular, the formation of the layer of carbon at the surface of the electrode may improve the overall electrical conductivity of the electrode, thus improving the utilization of the full capacity of the battery 900, particularly at charge rates above C/5. That is, the overall energy of the battery 900 may be improved. It should be noted that the combinatorial processing methods described above may be utilized to optimize the performance of the electrodes and/or the battery as a whole.

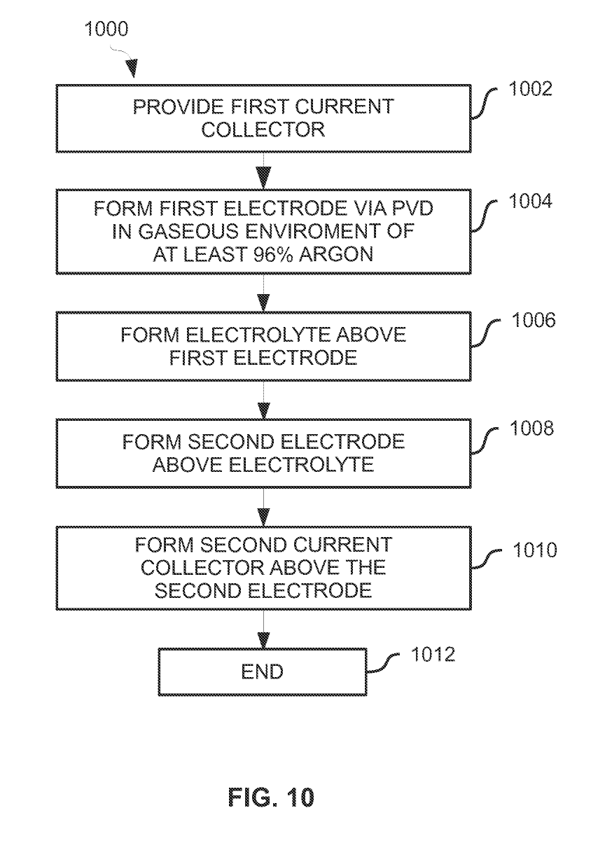

FIG. 10 illustrates a method 1000 for forming a solid-state lithium battery according to some embodiments. At block 1002, a first current collector (e.g., a cathode current collector) is provided. In some embodiments, the first current collector is formed above a substrate (e.g., aluminum oxide, silicon oxide, zirconium oxide, aluminum nitride, silicon, germanium, aluminum, titanium, stainless steel, and/or a polymer). The first current collector may include, for example, a noble metal, such as platinum, gold, cobalt, and/or palladium and have a thickness of, for example, between about 0.1 μm and 3.0 μm. The first current collector may be formed using, for example, physical vapor deposition (PVD) (e.g., sputtering) or plating.

At block 1004, a first electrode (e.g., a cathode) is formed above the current collector. In some embodiments, the first electrode includes lithium and cobalt (e.g., lithium-cobalt oxide) and has a thickness of, for example, between about 5 μm and about 15 μm, such as about 10 μm. The first electrode may be formed using PVD (e.g., sputtering). In some embodiments, the electrode is deposited in a gaseous environment of mostly argon, such as a gaseous environment consisting of at least 96% argon. For example, the gaseous environment may consist of 4% or less air (e.g., atmosphere) in argon (i.e., about 1-4% air and 96-99% argon gas).

Although not shown in FIG. 10, after the first electrode is formed, in some embodiments, the first electrode is exposed to air (i.e., the atmosphere). In some embodiments, the first electrode includes a layer of lithium carbonate at an upper portion (or surface) thereof. The first electrode may also include a series of cracks which manifest during the deposition process, which are at least partially filled by the lithium carbonate.

Additionally, block 1004 may include heating (e.g., annealing) the first electrode at a temperature of, for example, between about 600° C. and about 800° C. The heating process may be performed in a gaseous environment including oxygen, nitrogen, argon, and/or hydrogen (e.g., 80% nitrogen, 20% oxygen) with either ambient humidity, or no humidity. In some embodiments, the heating process is performed for a duration of, for example, greater than 30 minutes (e.g., 30-60 minutes). The heating process may utilize a temperature ramp rate of, for example, between about 5° C. and about 10° C. per minute (e.g., starting from room temperature). The heating process may convert the lithium carbonate to a carbon, which may at least partially fill some of the cracks in the first electrode.

At block 1006, an electrolyte is formed above the first electrode. The electrolyte may be a solid electrolyte formed, or deposited, using a PVD process. In some embodiments, the electrolyte includes LiPON and has a thickness of, for example, between about 1.0 μm and about 2.0 μm.

At block 1008, a second electrode (e.g., an anode) is formed above the electrolyte. The second electrode may include lithium metal and have a thickness of, for example, between 1.0 μm and 5.0 μm. The second electrode may be formed using, for example, PVD (e.g., sputtering).

At block 1010, a second current collector (e.g., an anode current collector) is formed above the second electrode. In some embodiments, the second current collector includes scandium, titanium, vanadium, chromium, manganese, iron, cobalt, nickel, copper, yttrium, zirconium, lanthanum, hafnium, molybdenum, tantalum, tungsten, titanium nitride, or a combination thereof. The second current collector may have a thickness of, for example, between about 0.1 μm and about 3.0 μm. The second current collector may be formed using, for example, PVD (e.g., sputtering).

Although not shown in FIG. 10, a protective layer (e.g., a nitride) may be formed above the second current collector. Additionally, in some embodiments, two sets of the components of the battery are formed on opposing sides of the substrate (i.e., a double-sided configuration), while in other embodiments, the components are only formed on one side of the substrate (i.e., a single-sided configuration). At block 1016, the method 1000 ends.

Thus, in some embodiments, methods for forming a solid-state battery are provided. A first current collector is provided. A first electrode is formed above the first current collector. The first electrode includes lithium and cobalt and is formed using PVD in a gaseous environment including at least 96% argon. An electrolyte is formed above the first electrode. A second electrode is formed above the electrolyte. A second current collector is formed above the second electrode.

In some embodiments, methods for forming a solid-state battery are provided. A first current collector is provided. A first electrode is formed above the first current collector. The first electrode includes lithium-cobalt oxide and is formed via sputtering in a gaseous environment including not more than about 4% air in argon. The first electrode is annealed. A solid electrolyte is formed above the first electrode after the annealing of the first electrode. The solid electrolyte includes lithium-phosphorous oxynitride. A second electrode is formed above the solid electrolyte. A second current collector is formed above the second electrode.

In some embodiments, methods for forming a solid-state battery are provided. A substrate is provided. A first current collector is formed above the substrate. A first electrode is formed above the first current collector. The first electrode includes lithium-cobalt oxide and is formed via sputtering in a first gaseous environment comprising between about 96% and about 99% argon and between about 1% and about 4% air. The first electrode is exposed to a second gaseous environment consisting of air. After the exposing of the first electrode to the second gaseous environment, the first electrode is heated at a temperature of between about 600° C. and about 800° C. A solid electrolyte is formed above the first electrode after the heating of the first electrode. The solid electrolyte includes lithium-phosphorous oxynitride. A second electrode is formed above the solid electrolyte. A second current collector is formed above the second electrode.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A method for forming a solid-state battery, the method comprising:
providing a first current collector;
forming a first electrode above the first current collector, wherein the first electrode comprises lithium and cobalt and is formed using physical vapor deposition (PVD) in a gaseous environment comprising not more than about 4% oxygen in argon;
forming an electrolyte above the first electrode;
forming a second electrode above the electrolyte; and
forming a second current collector above the second electrode.

2. The method of claim 1, further comprising annealing the first electrode before the forming of the electrolyte.

3. The method of claim 2, wherein the annealing of the first electrode comprises heating the first electrode at a temperature of between about 600° C. and about 800° C.

4. The method of claim 2, further comprising exposing the first electrode to a second gaseous environment consisting of air before the annealing of the first electrode.

5. The method of claim 3, wherein the forming of the first electrode and the exposing of the first electrode to the gaseous environment consisting of air causes the formation of a lithium carbonate layer on a surface of the first electrode.

6. The method of claim 5, wherein the annealing of the first electrode causes carbon to be formed on the surface of the first electrode, and further comprising removing at least some of the carbon from the surface of the first electrode.

7. The method of claim 6, wherein the removing of the at least some of the carbon from the surface of the first electrode comprises performing an ion etch on the surface of the first electrode, exposing the surface of the first electrode to a solvent, or a combination thereof.

8. The method of claim 1, wherein the first electrode comprises lithium-cobalt oxide, and a thickness of the first electrode is between about 5 micrometers (μm) and about 15 μm.

9. The method of claim 1, wherein the electrolyte comprises lithium-phosphorous oxynitride, the second electrode comprises lithium, the first current collector comprises at least one of gold, platinum, or a combination thereof, and the second current collector comprises at least one of scandium, titanium, vanadium, chromium, manganese, iron, cobalt, nickel, copper, yttrium, zirconium, lanthanum, hafnium, molybdenum, tantalum, tungsten, titanium nitride, or a combination thereof.

10. The method of claim 1, wherein the first current collector is formed above a substrate.

11. A method for forming a solid-state battery, the method comprising:
providing a first current collector, wherein the first current collector is formed above a substrate;
forming a first electrode above the first current collector, wherein the first electrode comprises lithium-cobalt oxide and is formed via sputtering in a gaseous environment comprising not more than about 4% oxygen in argon;
annealing the first electrode;
forming a solid electrolyte above the first electrode after the annealing of the first electrode, wherein the solid electrolyte comprises lithium-phosphorous oxynitride;
forming a second electrode above the solid electrolyte; and
forming a second current collector above the second electrode.

12. The method of claim 11, further comprising exposing the first electrode to a second gaseous environment consisting of air before the annealing of the first electrode.

13. The method of claim 12, wherein the annealing of the first electrode comprises heating the first electrode at a temperature of between about 600° C. and about 800° C.

14. The method of claim 13, wherein a thickness of the first electrode is between about 5 micrometers (μm) and about 15 μm.

15. The method of claim 14, wherein the solid electrolyte comprises lithium-phosphorous oxynitride, the second electrode comprises lithium, the first current collector comprises at least one of gold, platinum, or a combination thereof, and the second current collector comprises at least one of scandium, titanium, vanadium, chromium, manganese, iron, cobalt, nickel, copper, yttrium, zirconium, lanthanum, hafnium, molybdenum, tantalum, tungsten, titanium nitride, or a combination thereof.

16. A method for forming a solid-state battery, the method comprising:
providing a substrate;
forming a first current collector above the substrate;
forming a first electrode above the first current collector, wherein the first electrode comprises lithium-cobalt oxide and is formed via sputtering in a first gaseous environment comprising between about 96% and about 99% argon and between about 1% and about 4% oxygen;
exposing the first electrode to a second gaseous environment consisting of air;
after the exposing of the first electrode to the second gaseous environment, heating the first electrode at a temperature of between about 600° C. and about 800° C.;
forming a solid electrolyte above the first electrode after the heating of the first electrode, wherein the solid electrolyte comprises lithium-phosphorous oxynitride;
forming a second electrode above the solid electrolyte; and
forming a second current collector above the second electrode.

17. The method of claim 16, wherein the forming of the first electrode and the exposing of the first electrode to the second gaseous environment causes the formation of a lithium carbonate layer on a surface of the first electrode, and wherein the heating of the first electrode causes at least some of the lithium carbonate layer to be converted into carbon, and further comprising removing at least some of the carbon.

18. The method of claim 17, wherein the removing of the at least some of the carbon comprises performing an ion etch on the surface of the first electrode, exposing the surface of the first electrode to a solvent, or a combination thereof.

19. The method of claim 18, wherein a thickness of the first electrode is between about 5 micrometers (μm) and about 15 μm.

20. The method of claim 14, wherein the second electrode comprises lithium, the first current collector comprises at least one of gold, platinum, or a combination thereof, and the second current collector comprises at least one of scandium, titanium, vanadium, chromium, manganese, iron, cobalt, nickel, copper, yttrium, zirconium, lanthanum, hafnium, molybdenum, tantalum, tungsten, titanium nitride, or a combination thereof.
